(19) United States
(12) Patent Application Publication
(10) Pub. No.: US 2007/0071338 A1
(43) Pub. Date: Mar. 29, 2007

(54) Method or apparatus for processing performance data from a communications network

(75) Inventors: Bibartan Sen, Bangalore (IN); Swapnesh Banerjee, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., HOUSTON, TX (US)

(21) Appl. No.: 11/492,980

(22) Filed: Jul. 26, 2006

(30) Foreign Application Priority Data
Sep. 23, 2005 (IN) IN1353/CHE/2005

(51) Int. Cl. G06K 9/46

(52) U.S. Cl. 382/240

(57) ABSTRACT

A method and apparatus is disclosed for processing performance data from a communications network in which the performance data is converted from a time-series format into a time-frequency format and one or more frequency components removed prior to the data being utilised to monitor the network.

### BACKGROUND OF THE INVENTION

Communications network operators need efficient reporting applications to analyse the data generated from the network elements. The data may be traffic, fault or performance data. With the increase of subscribers and services in telecommunications, the volume of data generated has also grown significantly. As a result, the data as become increasingly difficult to handle and analyse efficiently. In addition to the scale of the data, the data itself can be more complex and include noise elements. Handling and storing such data involves large amounts of costly processing power and storage.

### BRIEF DESCRIPTION OF THE DRAWINGS

Embodiments of the invention will now be described, by way of example only, with reference to the accompanying drawings in which:

FIG. 1 is a schematic illustration of a communications network including a performance data processing system;

FIG. 2 is a schematic illustration of components of the performance data processing system of FIG. 1;

FIGS. 3 and 4 are flow charts illustrating processing carried out by the performance data processing system of FIG. 2;

FIG. 5 is a graph illustrating the results of the processing of FIG. 3;

FIG. 6a is a graph illustrating an example of call duration data for input to the performance data processing system of FIG. 2; and

FIGS. 6b and 6c are graphs each illustrating the output of the performance data processing system under different processing criteria.

### DETAILED DESCRIPTION OF EMBODIMENTS OF THE INVENTION

An embodiment provides a method for processing performance data from a communications network comprising one or more network elements, the method comprising the steps of:
a) receiving network data from a network element;
b) converting the network data from a time-series format to a time-frequency format;
c) modifying the converted network data by removing a first set of frequency components to create a first set of modified data; and
d) applying an anomaly detection algorithm to the first set of modified data.

The converting step may be performed with a wavelet transform. The converting step may be carried out with an Ordered Haar wavelet transform. The first set of frequency components may be removed by reducing to zero one or more corresponding spectrum coefficients produced by the wavelet transform. The method may comprise the further step of creating a second set of modified data from the network data by removing a second set of frequency components from the network data. The second set of frequencies may be removed by reducing to zero one or more wavelet coefficients produced by the wavelet transform. The second set of modified data may be transformed from the time-frequency format to the time-series format using an inverse wavelet transform.

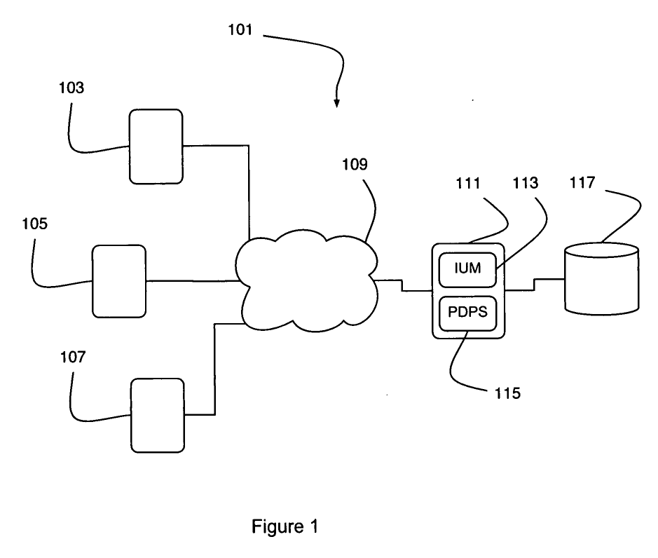

With reference to FIG. 1, a communications network 101, in the form of a telecommunications network for providing telecommunications services including internet services, comprises a number of network elements in the form of a set of switches 103,105, 107 connected to network infrastructure 109. The switches 103, 105, 107 are arranged to route traffic in the network 101. A network management system 111 in the form of a computer running an internet usage management (IUM) program 113, such as OpenView™ Internet Usage Manager™ from the Hewlett Packard Company, is also connected to the network infrastructure 109. The network management system 111 also includes a performance data processing system (PDPS) 115 described in further detail below. The network management system 111 is arranged to collect performance data from the network 101 and to analyse and store it in a database 117 for future use.

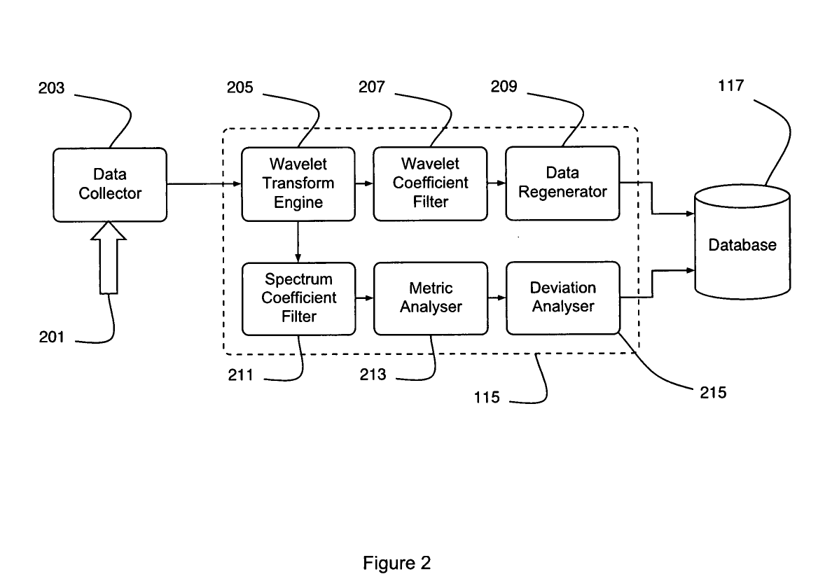

With reference to FIG. 2, the PDPS 115 receives network performance data 201 from the network elements 103, 105,107 via a data collection and normalising module 203 of the IUM program 113. The data collection and normalising module 203 is arranged to collect inbound data from a network element via a transfer protocol and to normalise the data into a standard structure for further processing. When the PDPS 115 has processed the data 201, its output is stored in the database 117. The PDPS 115 comprises a wavelet transform engine 205, which takes as its input the normalised data from the data collection and normalising module 203. The wavelet transform engine 205 is connected to a wavelet coefficient filter 207, which, in turn is connected to a data regenerator 209. The data regenerator 209 stores the results of its processing in the database 117. The wavelet transform engine is also connected to a spectrum coefficient filter 211, which is connected in turn to a metric analyser 213 and a deviation analyser 215. The deviation analyser 215 stores the results of its processing in the database 117.

The PDPS 115 is arranged to carry out two main processes. The first process is to convert the input data using a wavelet transform and then to modify the converted data by removing a first set of one or more frequency components to produce a first set of modified data. The first set of modified data is then used as the input for a deviation analysis process. The second process uses a copy of the same converted data and removes a second set of frequency components to produce a second set of modified data. The second set of modified data is then reconverted using an inverse wavelet transform to produce a compressed version of the input data. Each component of the PDPS is described in further detail below.

The wavelet transform engine 205 performs a time domain to frequency domain transformation of the input data using a wavelet transform. The choice of which wavelet to use is determined by the character of the input data as well as performance requirements. Wavelets allow transformations at different time scales, producing a set of averages called spectrum coefficients via a scaling function, and a set of differences called wavelet coefficients via a wavelet function. In the present embodiment, the transform engine uses an Ordered Haar wavelet which is a tree structured, recursive algorithm commonly referred to as a pyramidal algorithm. An advantage of the Haar wavelet transform is that it is fast in terms of execution time and efficient in terms of memory requirements.

The Haar transform produces a set of spectrum coefficients (aᵢ) and a set of wavelet coefficients (cᵢ) from successive data point (sᵢ, sᵢ₊₁) from an input data signal (s). The transform equations are as follows:
Wavelet equation: cᵢ=(sᵢ−sᵢ₊₁)/2, where cᵢ is a wavelet coefficient
Scaling function: aᵢ=(sᵢ+sᵢ₊₁)/2, where aᵢ is a spectrum coefficient

Given an input data signal having 2ⁿ data points, the above coefficients are calculated over a range of window sizes on the input data. In the present embodiment, the Haar wavelet transform is calculated across a window of data points in multiple passes, increasing the window size for each pass. The window size is also referred to as the resolution and defines the granularity at which the data is processed. In the present embodiment, the resolution is increased by a power of two with each pass giving window sizes of 2, 4, 8, 16 etc. In each pass, the window is shifted over the input data, with a new wavelet and spectrum coefficient being calculated with each shift. For example, if the input data contains 256 data points, the first window is shifted by two elements, 128 times and producing a set of 128 wavelet coefficients and a set of 128 spectrum coefficients. As the window size increases, the number of coefficients produced in a given pass reduces. For the spectrum coefficients the computation is as follows:
For (i=0; i<n; i=i+2), aᵢ=(sᵢ+sᵢ₊₁)/2.

The computation for the wavelet coefficients is as follows:
For (i=0; i<n; i=i+2), cᵢ=(sᵢ−sᵢ₊₁)/2.

The spectrum coefficient filter 211 takes the results of the scaling equation in the form of sets of spectrum coefficients. The spectrum coefficient filter 211 is arranged to remove one or more frequency components from the transformed data in order to filtering out unwanted frequencies and thereby enable a more accurate analysis process and to optimise storage. The spectrum coefficients themselves are used for deviation analysis and anomaly detection as described below. The sets of spectrum coefficients are generated in the following form:
{Sᵢ, where 0<i<n/2}
{Sᵢ, where 0<i<n/4}
{Sᵢ, where 0<i<1}

Each of these sets correspond to the wavelet transform at a different window resolution. In order to filter out one or more frequency components, the corresponding set or sets of coefficients are set to zero. The choice of sets of coefficients to be filtered out effects the accuracy of the deviation analysis. In the present embodiment, 50% of the coefficients are removed by reducing alternate sets of coefficients to zero.

The metric analyser 213 calculates a metric for use in analysing the current data (D) against historical data (D′). Given these two sets of data, the metric computation unit computes the following metric:
C=(·((D′x−Dx)²)/2
for all x, where D′ᵢx are the spectrum coefficients of the historical data (D′) and Dᵢx are the spectrum coefficients of the current data (D).

Since the coefficients used for the above metric are filtered, the number of coefficient data points representing the signal is reduced from that of the original signal.

The deviation analyser 215 applies a set of thresholds to the results of the metrics analyser 213 to determine whether or not the results from the metric C represent an anomaly or not. In the present embodiment, the thresholds are static and the output from the deviation analyser indicates either the presence or absence of anomalies.

As noted above, in the second process in which the input data is compressed and stored, the output from the wavelet transform engine, in the form of the wavelet coefficients, is fed to the wavelet coefficient filter. The wavelet coefficient filter 207 is arranged to filter out a subset of the wavelet coefficients. The filtered data is designed to be sufficient to regenerate accurate time-series representations of the original data. The filtering criterion are thus a trade off between regeneration accuracy and storage requirements. The wavelet coefficients are generated in sets by the wavelet transform engine as follows:
{Cᵢ, where 0<i<n/2}
{Cᵢ, where 0<i<n/4}
{Cᵢ, where 0<i<1}

Each set corresponds to the wavelet transform at a different window resolution. In order to filter out one or more frequency components, the corresponding set or sets of coefficients are set to zero. In the present embodiment, 50% of the coefficients are removed by reducing alternate sets of coefficients to zero.

The data regenerator 209 then applies an inverse wavelet transform, using the filtered wavelet coefficients and the mean value of the original data signal, to regenerate the original time series data. The regenerated data is stored in the database 117 for further use via the IUM program to analyse the performance of the relevant network element.

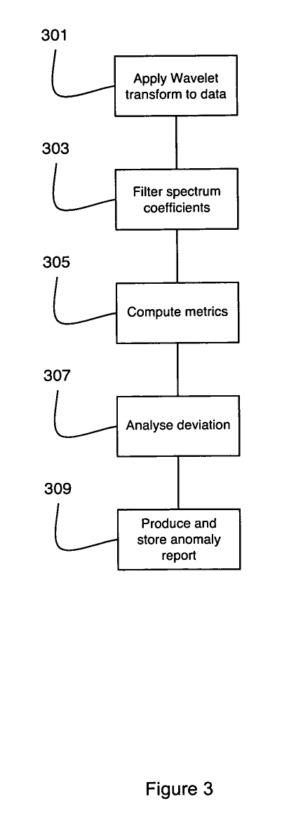

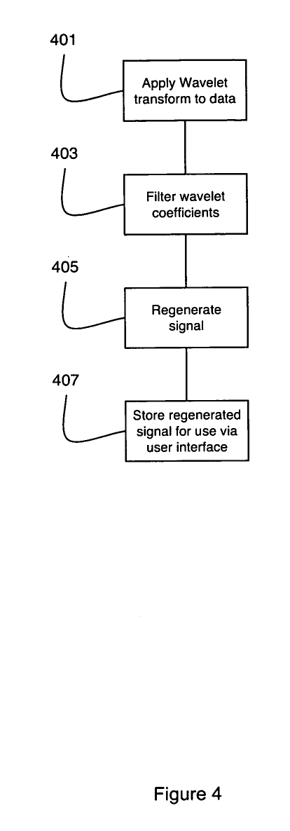

The processing carried out by the PDPS 115 will now be summarised with reference to the flow charts of FIGS. 3 and 4. With reference to FIG. 3, the first process begins at step 301 when the input data signal comprising n data points is received from the IUM program and the wavelet transform is applied to produce the sets of spectrum coefficients at resolutions of 2ⁿ. Processing then moves to step 303 where 50% of the sets of coefficients are set to zero thus compressing the data by 50%. Processing the moves to step 305 where the metric is calculated on the modified spectrum coefficients with respect to a selected historical data set stored in the database 117. Processing then moves to step 307 where any anomalies in the current data are compared to the static threshold and flagged if the threshold is exceeded. Processing then moves to step 309 where the flagged anomalies, if any, are stored in the database 117 along with the modified current data.

With reference to FIG. 4, the second process begins at step 401 when the input data comprising n data points is received from the IUM program and the wavelet transform is applied to produce the sets of spectrum coefficients at successive resolutions of 2ⁿ. Processing then moves to step 403 where 50% of the sets of coefficients are set to zero thus compressing the data by 50%. Processing then moves to step 405 where an inverse wavelet transform is applied to the modified data and at step 407 the compressed data is stored in the database 117 to enable analysis of the performance of the network element 103 via the IUM program.

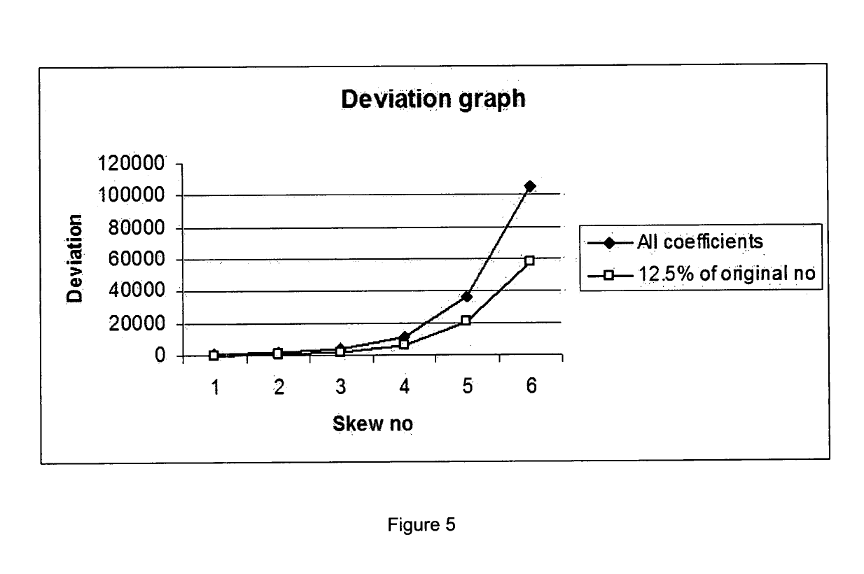

FIG. 5 is a graph illustrating the performance of the deviation analyser 215 for two sets of input. The first set of input has a full complement of spectrum coefficients while the second set has only 12.5% or one eighth of its original spectrum coefficients. The graph shows that even with successive units of 20% distortion (skew) being introduced into the data, the performance from the data with filtered spectrum coefficients is comparable to that from the full set of data. Thus analysis using filtered spectrum coefficients is effective even at high levels (such as 87.5%) of spectrum coefficient filtering.

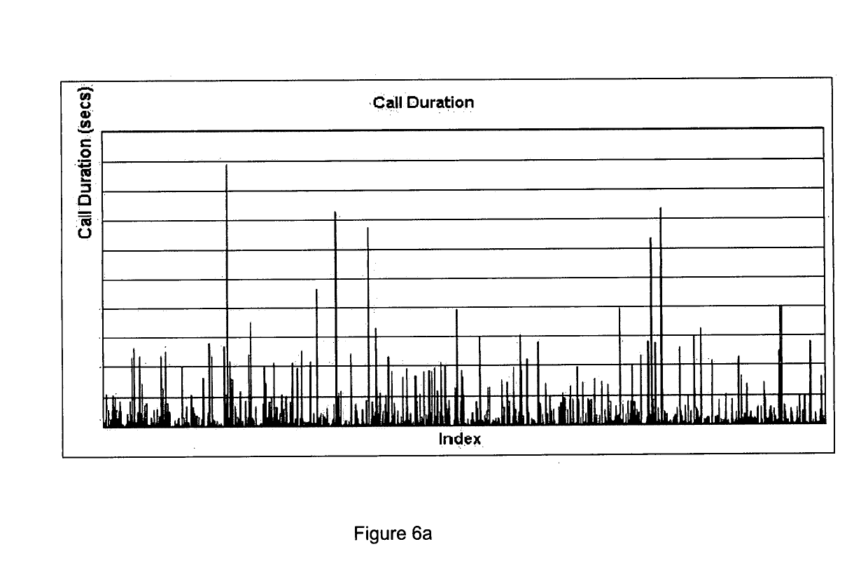

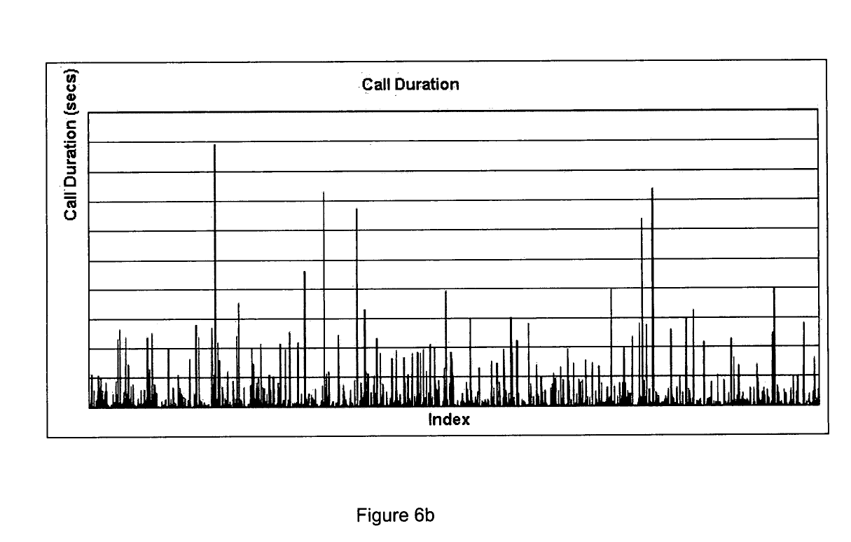

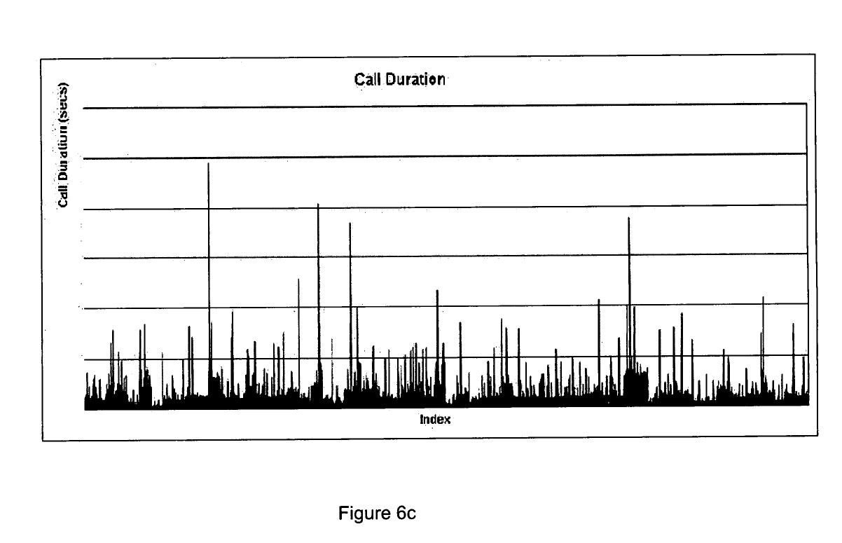

FIG. 6a shows call duration data, comprising 2048 data points, from a network element, that has been collected and normalised by the IUM program. FIG. 6b shows the same data processed by the PDPS 115 by removing 50% of the wavelet coefficients and then regenerating the signal. The regenerated signal mirrors the original signal in a consistent way despite the compression of data. FIG. 6c show the same data as shown in FIG. 6a but with 87.5% of the wavelet coefficients removed. Even at this level of compression the data is comparable to the original data and could therefore be used for analysis of the performance of the network element from which the data originated.

In another embodiment, the selection of spectrum or wavelet coefficients to be reduced to zero is made randomly. In a further embodiment, the selection of spectrum or wavelet coefficients to be reduced to zero is carried out in accordance with a predefined mathematical function. In another embodiment, the selection of spectrum or wavelet coefficients to be reduced to zero is spread evenly across the sets of coefficients.

In a further embodiment, the PDPS is arranged to carry out only the first, anomaly detection process. In another embodiment, the PDPS is arranged to only carry out the second, data compression process.

In a further embodiment, the anomaly detector is arranged to apply static and/or adaptive thresholds to the metrics to detect anomaly conditions in the data. In another embodiment, the anomaly detector is arranged to provide data on the degree to which an anomaly has been detected and to provide qualitative measures of the anomaly.

It will be understood by those skilled in the art that the filtering criteria used is dependent on the performance and accuracy required in the particular application of the above method an apparatus. In other words, there is a trade-off between compression or noise removal and the performance and accuracy of the system.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means so that the software can be loaded onto one or more devices.

There has been described a method for processing performance data from a communications network comprising one or more network elements, the method comprising the steps of:
a) receiving network data from a network element;
b) converting the network data from a time-series format to a time-frequency format using a wavelet transform;
c) modifying the converted network data by removing a first set of frequency components to create a first set of modified data; and
d) reconverting the first set of modified data from the time-frequency format to the time-series format using an inverse wavelet transform.

The method may comprise the further step creating a second set of modified data from the network data, removing a second set of frequency components from the network data and applying an anomaly detection algorithm to the second set of modified data.

There has been also described apparatus for processing performance data from a communications network comprising one or more network elements, the apparatus being operable to:
receive network data from a network element;
convert said network data from a time-series format to a time-frequency format;
modify said converted network data by removing a first set of frequency components to create a first set of modified data; and
apply an anomaly detection algorithm to said first set of modified data.

There has also been described apparatus for processing performance data from a communications network comprising one or more network elements, the apparatus being operable to:
receive network data from a network element;
convert said network data from a time-series format to a time-frequency format using a wavelet transform;
modify said converted network data by removing a first set of frequency components to create a first set of modified data; and
reconvert said first set of modified data from said time-frequency format to said time-series format using an inverse wavelet transform.

Also described has been apparatus for processing performance data from a communications network comprising one or more network elements, the apparatus comprising:
means for receiving network data from a network element;
means for converting said network data from a time-series format to a time-frequency format;
means for modifying said converted network data by removing a first set of frequency components to create a first set of modified data; and
means for applying an anomaly detection algorithm to said first set of modified data.

Also described has been apparatus for processing performance data from a communications network comprising one or more network elements, the apparatus comprising:
means for receiving network data from a network element;
means for converting said network data from a time-series format to a time-frequency format using a wavelet transform;
means for modifying said converted network data by removing a first set of frequency components to create a first set of modified data; and
means for reconverting said first set of modified data from said time-frequency format to said time-series format using an inverse wavelet transform.

Another aspect of the embodiment described has been a program or group of programs arranged to enable a programmable device or a group of programmable devices to carry out a method for processing performance data from a communications network comprising one or more network elements, the method comprising the steps of:
a) receiving network data from a network element;
b) converting the network data from a time-series format to a time-frequency format;
c) modifying the converted network data by removing a first set of frequency components to create a first set of modified data; and
d) applying an anomaly detection algorithm to the first set of modified data.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for processing performance data from a communications network comprising one or more network elements, the method comprising the steps of:
a) receiving network data from a network element;
b) converting said network data from a time-series format to a time-frequency format;
c) modifying said converted network data by removing a first set of frequency components to create a first set of modified data; and
d) applying an anomaly detection algorithm to said first set of modified data.

2. A method according to claim 1 in which said converting step is performed with a wavelet transform.

3. A method according to claim 1 in which said converting step is carried out with an Ordered Haar wavelet transform.

4. A method according to claim 2 in which said first set of frequency components are removed by reducing to zero one or more corresponding spectrum coefficients produced by said wavelet transform.

5. A method according to claim 1 comprising the further step of creating a second set of modified data from said network data by removing a second set of frequency components from said network data.

6. A method according to claim 5 in which said second set of frequencies is removed by reducing to zero one or more wavelet coefficients produced by said wavelet transform.

7. A method according to claim 5 in which said second set of modified data is transformed from said time-frequency format to said time-series format using an inverse wavelet transform.

8. A method for processing performance data from a communications network comprising one or more network elements, the method comprising the steps of:
a) receiving network data from a network element;
b) converting said network data from a time-series format to a time-frequency format using a wavelet transform;
c) modifying said converted network data by removing a first set of frequency components to create a first set of modified data; and
d) reconverting said first set of modified data from said time-frequency format to said time-series format using an inverse wavelet transform.

9. A method according to claim 8 comprising the further step of creating a second set of modified data from said network data by removing a second set of frequency components from said network data, and applying an anomaly detection algorithm to said second set of modified data.

10. Apparatus for processing performance data from a communications network comprising one or more network elements, the apparatus comprising:
means for receiving network data from a network element;
means for converting said network data from a time-series format to a time-frequency format;
means for modifying said converted network data by removing a first set of frequency components to create a first set of modified data; and
means for applying an anomaly detection algorithm to said first set of modified data.

11. Apparatus for processing performance data from a communications network comprising one or more network elements, the apparatus comprising:
means for receiving network data from a network element;
means for converting said network data from a time-series format to a time-frequency format using a wavelet transform;
means for modifying said converted network data by removing a first set of frequency components to create a first set of modified data; and
means for reconverting said first set of modified data from said time-frequency format to said time-series format using an inverse wavelet transform.

12. A medium or media containing therein a program or group of programs arranged to enable a programmable device or a group of programmable devices to carry out the method of claim 1.

13. A medium or media containing therein a program or group of programs arranged to enable a programmable device or a group of programmable devices to provide the apparatus of claim 10.
